(19) United States
(12) Patent Application Publication
(10) Pub. No.: US 2023/0200296 A1
(43) Pub. Date: Jun. 29, 2023

(54) ELECTRIC VEHICLE WITH MULTIPLE PORTS

(71) Applicant: BRIGGS & STRATTON, LLC, (US)

(72) Inventors: Jeffrey Zeiler, Pewaukee, WI (US); Scott Funke, New Berlin, WI (US); Mark Noller, Milwaukee, WI (US); Warren Corrado, Wauwatosa, WI (US)

(73) Assignee: BRIGGS & STRATTON, LLC, Wauwatosa, WI (US)

(21) Appl. No.: 17/766,995

(22) PCT Filed: Oct. 14, 2020
(86) PCT No.: PCT/US20/55594

§ 371 Date: Apr. 6, 2022

Related U.S. Application Data
(60) Provisional application No. 62/915,558, filed on Oct. 15, 2019.
(60) Provisional application No. 62/983,456, filed on Feb. 28, 2020.

(51) Int. Cl. A01D 34/78; B60K 1/04; B60K 7/00; A01D 69/02

(52) U.S. Cl. CPC A01D 34/78; B60K 1/04; B60K 7/0007; A01D 69/02; A01D 2101/00

(57) ABSTRACT

Systems and apparatuses include a lawn mower including a frame, a deck coupled to the frame, and an electric power take off outlet coupled to the frame and structured to electrically couple with a battery. The electric power take off outlet including a power port structured to electrically couple to a peripheral device, and a data port structured to communicate with the peripheral device.

### CROSS-REFERENCE TO RELATED PATENT APPLICATIONS

This application is claims the benefit of U.S. provisional patent application no. 62/915,558 filed on Oct. 15, 2019, and U.S. provisional patent application no. 62/983,456 filed on Feb. 28, 2020. The entire contents of these applications are incorporated herein by reference.

### BACKGROUND

The present application relates generally to outdoor power equipment. More specifically, the present application relates to electric outdoor power equipment in the form of an electric mower, which may be battery powered.

### SUMMARY

At least one embodiment relates to a lawn mower that includes a frame, a deck coupled to the frame, and an electric power take off outlet coupled to the frame and structured to electrically couple with a battery. The electric power take off outlet includes a power port structured to electrically couple to a peripheral device, and a data port structured to communicate with the peripheral device.

Another embodiment relates to an electric vehicle that includes a frame, a deck coupled to the frame, and an electrical system including a traction motor controller structured to receive power from a vehicle battery and provide power to an electric traction motor, and a distribution box structured to electrically coupled with the battery and including a plurality of electric power take off outlets each including a power port structured to electrically couple a peripheral device, and a data port structured to communicate with the peripheral device, and a chore motor controller communicably coupled with the power port and the data port of a first electric power take off outlet.

Another embodiment relates to an electric vehicle that includes a frame, a deck coupled to the frame, an electric chore motor coupled to the deck, a chore motor controller communicably coupled to the chore motor, a distribution box positioned adjacent the deck and electrically coupled with the electric chore motor and the chore motor controller to provide power and communication therebetween, and an electric power take off outlet including a power port structured to electrically couple a peripheral device, and a data port structured to communicate with the peripheral device.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description when taken in conjunction with the accompanying figures.

FIG. 1 is a diagram of modular wiring for a piece of outdoor equipment in the form of a stand-on electric mower.

FIG. 2 is a diagram of modular wiring for a piece of outdoor equipment in the form of a stand-on electric mower having a separate chore motor controller.

FIG. 3 is a schematic diagram of connectors with connection interfaces that are included in the distribution box of FIGS. 1-2.

FIGS. 4A-4B are perspective views of the distribution box of FIG. 1 without any male connectors coupled to the outlets.

FIGS. 4C-4D are perspective views of the distribution box of FIG. 1 with male connectors coupled to the outlets.

FIG. 5 is a front perspective view of a portion of an electric stand-on mower and the distribution box of FIG. 2.

FIG. 6 is a front perspective view of outdoor power equipment, specifically an electric stand-on mower.

FIG. 7 is a front perspective view of connections of multiple devices to the outdoor power equipment of FIG. 6.

FIG. 8 is another front perspective view of connections of multiple devices to the outdoor power equipment of FIG. 6.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Although the description and figures herein describe the structure and operation of an electric mower, it should be understood that the components describe herein could be utilized with other types of electric vehicles or electric power equipment. Electric vehicles or electric power equipment may include outdoor power equipment such as riding tractors, snow throwers, pressure washers, tillers, log splitters, zero-turn radius mowers, walk-behind mowers, riding mowers, pavement surface preparation devices, industrial vehicles such as forklifts, utility vehicles, commercial turf equipment such as blowers, vacuums, debris loaders, overseeders, power rakes, aerators, sod cutters, brush mowers, sprayers, spreaders, etc. An electric vehicle may also be other types of utility vehicles such as all-terrain vehicle (ATVs) and other off-road vehicles (ORVs).

Referring to the figures generally, power take-off (PTO) ports for an electric vehicle are illustrated. In some embodiments, the multiple PTO ports are positioned in a single location, such as a distribution box located proximate the deck of the electric vehicle (e.g., a stand-on electric mower). The multiple PTO ports may instead be in various locations, such as in a distribution box, integrated with the dashboard, or integrated proximate drive wheels on a side of the electric vehicle. The PTO ports may provide a connection interface for powering an implement to use with outdoor power equipment, such as a brush, a blower, a vacuum, a light, a string trimmer, an edger, etc. In some embodiments, the PTO ports provide a charging interface to couple a secondary battery pack or charger that is used to recharge the primary power supply (e.g., a main battery) of the electric vehicle. For example, if the electric vehicle depletes primary power while out in the field (e.g., during a job), a backup battery pack or portable generator may plug into the PTO ports of the electric vehicle to provide backup power (e.g., provide power to the drive wheels). Beneficially, the use of the multiple PTO ports to recharge the main battery of the electric vehicle can increase the running time during which the electric vehicle may be operated, since an operator can provide secondary power via the PTO ports and the smaller, ancillary battery pack to recharge the battery supply of the electric vehicle. As such, the electric vehicle can then operate long enough to drive back to a transportation vehicle (e.g., a trailer) and/or charging station, limiting the risks of using the electric vehicle at a greater range and having the electric vehicle run out of power.

Furthermore, if the primary power of the electric vehicle unexpectedly fails, the PTO ports can be utilized to provide secondary power in order to complete a job with the vehicle or operate the vehicle for an extended duration of time to drive it back to the transportation vehicle. Additionally, the multiple PTO ports can allow an operator of the electric vehicle to power other equipment, such as a blower, vacuum, light, cutter, brush, string trimmer, edger, or other types of implements, while running the electric vehicle. This may save an operator from having to cover the same area more than once during a job, which can drastically reduce the amount of time, battery power, and use of other resources during the job. In some embodiments, the multiple PTO ports are directly integrated with the primary battery supply of the electric vehicle. In other embodiments, the PTO ports may be near a dashboard of the electric vehicle and connect to the main battery supply of the electric vehicle via power and communication lines. The PTO ports can also allow an operator of the electric vehicle to easily recharge the battery supply of the electric vehicle or power an implement without requiring tools to connect and disconnect the secondary battery supply, charger, and/or implements to the electric vehicle. The PTO ports, distribution box, motor controllers, and motors described herein may be used in purely electric systems (e.g., the electric vehicle is only powered by a battery). In other embodiments, the PTO ports, distribution box, motor controllers, and motors described herein can be utilized in hybrid systems (e.g., systems powered by an internal combustion engine and generator or systems powered by an internal combustion engine, a generator, and a battery).

In some embodiments, the PTO ports on the electric vehicle receive a connection interface of a data communication pin positioned between two power pins from a male connector of a cable connected to an implement or motor. The two power pins may be a +48 Volt (V) pin and a −48 Volt (V) pin. The positive terminal of the battery may be 48V higher than the negative terminal. The negative terminal of the battery may be 48V lower than the positive terminal. In other embodiments, the power pins may accept voltages greater or less than 48V. The PTO ports may include other form factors for an outlet to receive a connection interface of a secondary power supply (e.g., a backup battery pack) or to power an object connected to the PTO port (e.g., an implement, a mobile device, a chore motor, etc.). For example, the PTO ports may include a Universal Serial Bus Type-C (USB-C) port in order to charge a mobile device of the operator. The functioning of the PTO ports may be controlled via a user interface of the power equipment, such as a dashboard proximate the location where a user stands to operate the equipment. For example, the PTO ports may be turned on to power implements or receive power from an ancillary battery pack via a switch on a user dashboard.

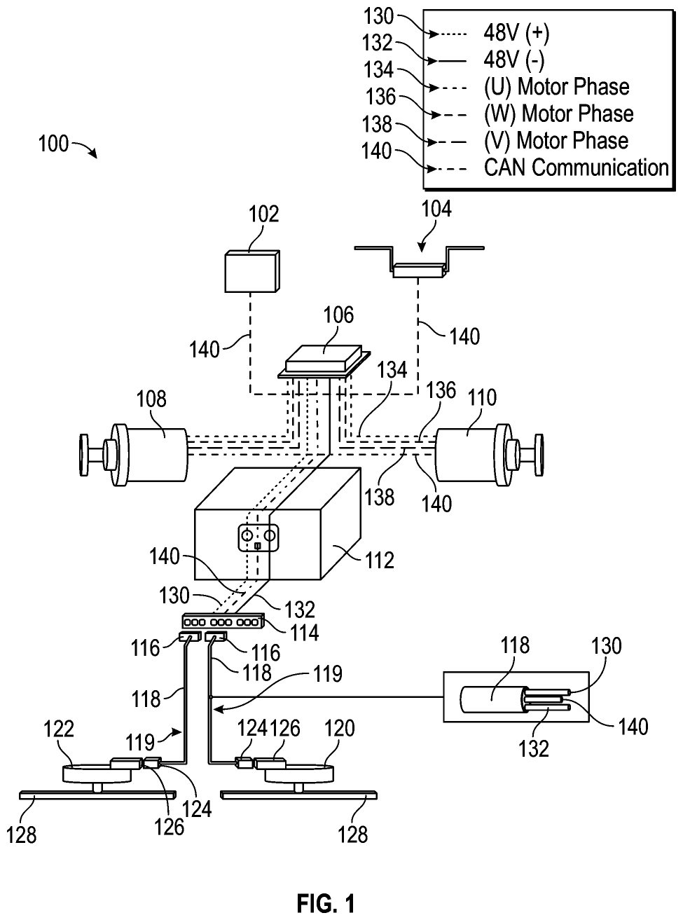

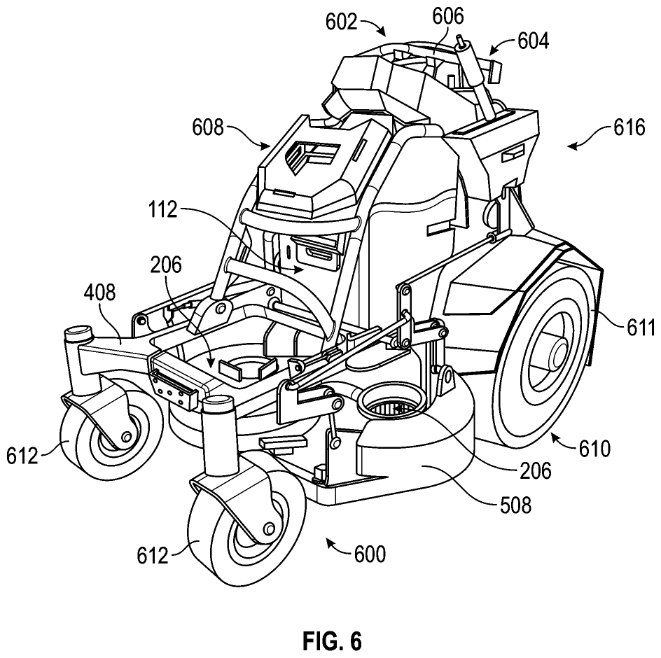

Referring to FIG. 1, a diagram 100 of the modular wiring for a piece of electric vehicle (e.g., a stand-on electric mower) is illustrated, according to some embodiments. The diagram 100 includes a display 102, inputs 104, a traction motor controller 106, a left traction motor 108, a right traction motor 110, a battery 112, a distribution box 114, a distribution box male connector 116, a cord 119 with a combined cable 118 and a male 166 and female 124 connector, a left chore motor/controller 122, a right chore motor/controller 120, each motor having a motor male connector 126, and a blade 128 driven by each chore motor of chore motors/controllers 122, 120. Left chore motor/controller 122 and right chore motor/controller 120 both have a chore motor with an integrated motor controller. FIG. 1 also shows a legend for the wiring of these components in a mower 600 (FIG. 6). The legend includes a positive 48V line 130, a negative 48V line 132, a motor phase U line 134, a motor phase V line 136, a motor phase W line 138, and a data communication line 140 (e.g., controller area network (CAN) bus data communication line). The combined cable 118 includes the positive 48V line 130, the negative 48V line 132, and the data communication line 140. The combined cable 118 may include different voltage lines than the positive 48V line 130 and the negative 48V line 132 (e.g., a positive voltage line greater or less than 48V and a negative voltage line greater or less than 48V) in other embodiments.

The display 102 can be integrated into a programmable user interface displayed on the dashboard 602 of the mower 600 (FIG. 6) to provide information on the operation of the mower to a user of the mower. For example, the display 102 may show the amount of energy stored in the battery 112, one or more motors connected to the distribution box 114, any implements connected to the distribution box 114, the direction of the mower, user options to turn on or off implements or motors connected to the distribution box, vehicle speed, blade speed, amount of power being consumed, system faults, etc. In some embodiments, the display 102 is a light emitting diode (LED) screen, a touch screen, a resistive touch screen, a capacitive touch screen, etc. The inputs 104 can include instructions from the operator of the mower to change the course of the mower, and/or change mower speed, and/or change blade speed, and/or engage and disengage motors and/or implements connected to the mower. The inputs 104 can be entered via a programmable user interface of the display 102 and/or input levers, joysticks, etc. For example, a user interface of the display 102 provides a selectable button to turn on a brush attached as an implement for the mower to the distribution box 114 and inputs 104 can include the signal to turn off the brush. The inputs 104 may be communicated to the traction motor controller 106, a left chore motor/controller 122, and a right chore motor/controller 120 via the CAN bus communication line 140 to increase or decrease the speed of the respective motor. In some embodiments, the inputs 104 include an instruction to increase the speed of the mower. For example, the traction motor controller 106 may instruct the left traction motor 108 and the right traction motor 110 to increase the rotational speed of the motors, thus causing the rear drive wheels 610 (FIG. 6) to turn faster and move the mower forward at a quicker pace.

The traction motor controller 106 can receive power and communications from the battery 112 via the positive 48V power line 130, the negative 48V power line 132, and the CAN bus communication line 140. In some embodiments, the battery 112 supplies more or less voltage than the 48V shown in FIG. 1, such as 72V or 36V. The traction motor controller 106 may also be connected to the left traction motor 108 and separately connected to the right traction motor 110 via the motor phase U line 134, the motor phase W line 136, and the motor phase V line 138. The three different motor phase lines can be used to transfer power to motors of the mower using a three-wire, three-phase circuit, where each wire is a conductor carrying alternating current with the same frequency, but a third of a cycle phase difference between each conductor. In some embodiments, the traction motor controller 106 may configure the conductors connecting to the left traction motor 108 and the right traction motor 110.

The diagram 100 is also shown to include a battery 112. The battery 112 can be positioned beneath a hood area 608 of the electric vehicle (e.g., mower 600 (FIG. 6)). The hood area 608 may allow air to flow through for ventilation and/or cooling purposes. The hood area 608 may generally be an open area and can include a hood “shield” to add additional protection to the battery 112 and a tubular frame to provide protection to the battery 112 from impacts and brush (e.g., tree branches). The battery 112 can provide electrical energy to the components of the electric vehicle including, but not limited to, the distribution box 114, the left chore motor/controller 122 and the right chore motor/controller 120 (via the PTO ports of the distribution box 114), the traction motor controller 106, the left traction motor 108, the right traction motor 110, the display 102, etc. In some embodiments, two power leads (e.g., the positive 48V power line 130 and the negative 48V power line 132) run from the battery 112 to bus bars of the distribution box 114, and each PTO port of the distribution box 114 is connected to the bus bars. In some embodiments, the battery 112 is liquid-cooled. In this embodiment, the battery 112 can be pre-heated for cold operation or during charging when cold using a heating element placed in the liquid flow path used for the liquid-cooled system. In some embodiments, the battery 112 includes a management system to control and monitor the operation thereof. The control system of the electric vehicle can dynamically interface with the management system of the battery 112 to ensure optimal operation of the electrical vehicle while protecting the battery 112. The battery 112 can include one or more distinct batteries including one or more battery cells (e.g., lithium ion battery cells and/or any other type of battery cell as described herein or that is suitable).

The battery 112 can be a lithium-ion (Li-ion) battery, a lithium-ion Polymer (LiPo) battery, a lead-acid battery, a nickel-cadmium (NiCd) battery, a nickel-metal hydride (NiMh) and/or any other type of battery configured to store and/or discharge energy. The battery 112 has a capacity of 7.2 kWh. In other embodiments, the battery 112 may have various capacities, e.g., 0.1 kWh, 0.5 kWh, 1 kWh, 3 kWh, 10 kWh, 50 kWh, etc. The battery 112 may also be a capacitor, ultracapacitor, bank of capacitors, etc. The battery 112 may be part of a power supply of a hybrid power system (e.g., systems powered by an internal combustion engine, a generator, and a battery). In some embodiments, the battery 112 has a nominal voltage rating of 48V. In other embodiments, the battery 112 may have a lower or greater nominal voltage rating.

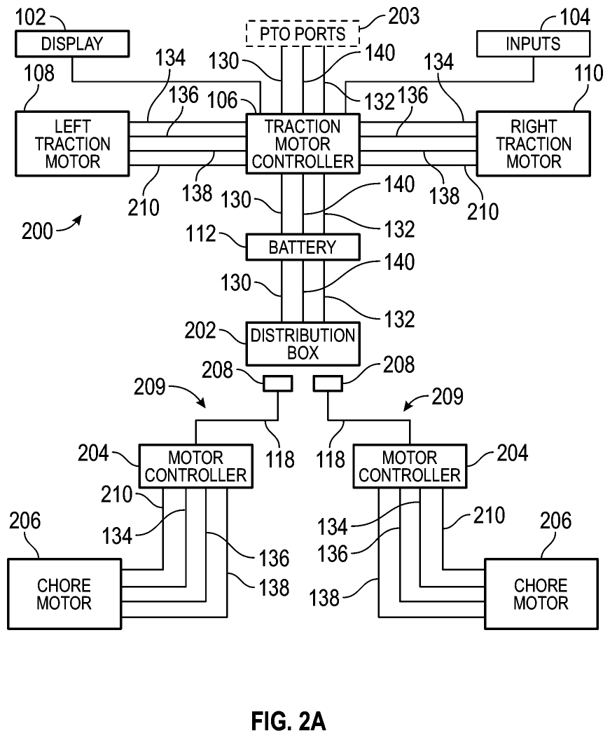

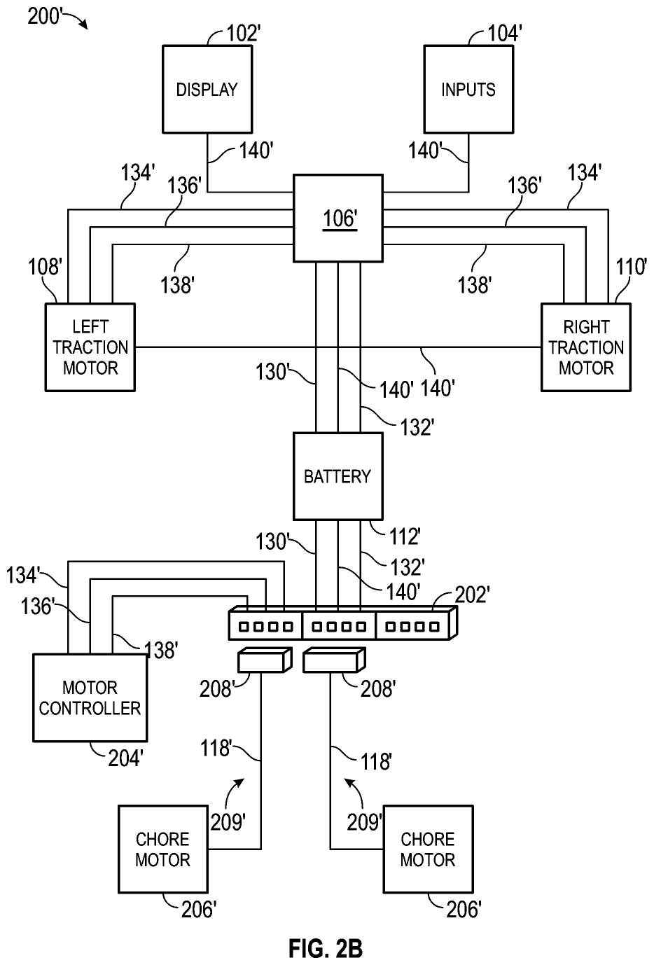

The distribution box 114 can be a female connector block that provides one or more outlets (e.g., PTO ports 203 (FIG. 2)) to connect to motors and motor controllers of the electric vehicle and to implements to use with the electric vehicle (e.g., an electric stand-on mower). The outlets of the distribution box 114 allow for removal and disconnect of each chore motor located on a cutting deck of the mower and plugged into the distribution box without needing tools. Beneficially, the ability to easily connect and disconnect plugs for chore motors and/or controllers improves the ease with which a user of the mower can swap out a mower deck with a different size mower deck. The outlets can also provide the ability to plug in, easily remove, and interchange implements as an accessory of the mower. Implements can include, but are not limited to, leaf/debris blowers, snowblowers, brushes, vacuums, brushcutters, sod cutters, aerators, overseeders, power rakes, lights, a mower deck, and any other accessory that can have an application while using the mower. In some embodiments, the distribution box 114 is directly coupled to the frame of the mower on the underside of the frame above a mower deck area.

In conventional applications, power and communication lines from a battery (e.g., the battery 112) go directly to motor controllers for controlling the operation of motors for the electric vehicle. The use of the distribution box 114 as described herein allows connections to be made directly to chore motors 206 with an integrated chore motor controller 204 and other implements. The connections of battery lines to the motor controllers first, as is traditionally done, involves more wiring and complicates the process of removing a motor from the mower or changing the size of the cutting deck of the mower. Furthermore, the distribution box 114 simplifies changeover of implements. By having a distribution box 114, implements attached to a mower can easily be removed or serviced without the use of tools and additional wiring normally needed to provide power and communications to the implements is eliminated. As such, an operator of an electric vehicle can simply change out the implements connected to the electric vehicle using the quick, tool-less wire connections to the distribution box 114.

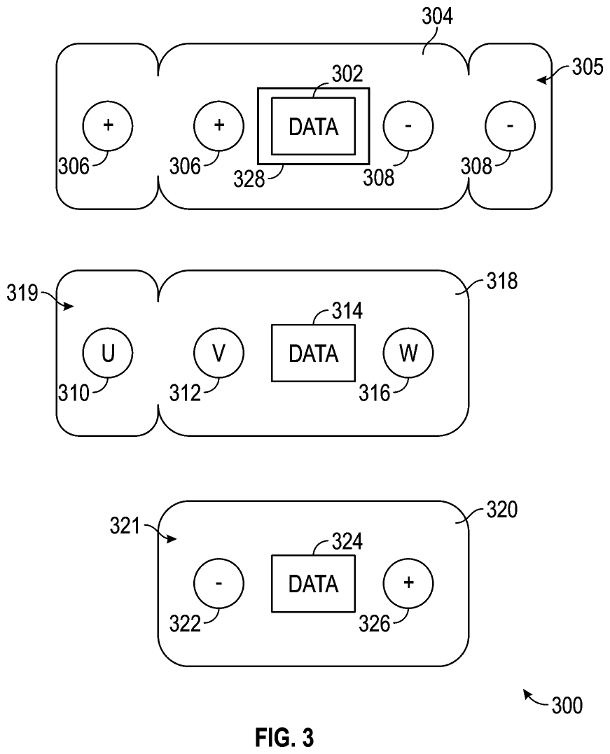

In other embodiments, the female connector outlets of the distribution box 114 may instead be directly built in to the battery 112 to decrease the amount of cables involved in the wiring of the diagram 100 even further. In some embodiments, the distribution box 114 has three outlets, each outlet with two ports for power lines and a port for a communication line. In some embodiments, the port for the communication line is positioned in between the two ports for power lines. However, in some embodiments, the port for the communication line is positioned elsewhere within the outlet to reduce a potential for electromagnetic interference. For example, an outlet may have a connection interface the same as connection interface 321 of connector 320 (FIG. 3) and a male connector then plugs into the outlet of the distribution box 114 directly using the three ports of the outlet. In other embodiments, the distribution box 114 has outlets with two cylindrical, positive, power ports on one side of a data connection port and two cylindrical, negative, power ports on the other side of the data connection port (e.g., connection interface 305 of connector 304 as shown in FIG. 3). The distribution box 114 may be waterproof and have airtight and watertight seals to prevent damage to any of the outlets that are included in the distribution box 114.

In some embodiments, the outlets of the distribution box 114 are coupled to a distribution box male connector 116. The distribution box male connector 116 can include a plug to connect to each port of the female connection outlet of the distribution box 114. In other embodiments, the distribution box male connector 116 includes a second interface for coupling to the distribution box male connector 116 with another connector. The second interface can include the same female ports that the first interface of the distribution box male connector 116 plugged into in an outlet of the distribution box 114. As such, the distribution box male connector 116 may allow another male connector to plug into the second interface, the second connector building off the first distribution box male connector 116. This interlocking feature of connectors can advantageously allow additional implements to be used as an accessory even when the outlets of the distribution box 114 already have a motor or implement connected to each outlet. In some embodiments, when one or more implements are connected to the distribution box 114, the amount of current used by each of the implements is monitored. If two or more implements draw an amount of current over a certain threshold, a warning may be indicated on the display 102 and all but one of the implements may automatically be turned off to prevent the high current implements from operating simultaneously.

A cord 119 may connect the left and right chore motors/controllers 122 and 120 to the distribution box 114. The cord 119 may include the distribution box male connector 116, the combined cable 118, and the motor female connector 124. The combined cable 118 can include the positive 48V power line 130, the negative 48V power line 132, and the CAN communication line 140 in a single enclosure to decrease the amount of cables running between the distribution box 114 and the left and right chore motors/controllers 122, 120 and the other motors of the mower. In some embodiments, the combined cable 118 includes two power lines and two communication signal lines. In some embodiments, the distribution box 114 can also be connected to the traction motor controller 106 to reduce the number of cables connecting various components of the mower further. The motor female connector 124 may couple to the left and right chore motors/controllers 122, 120 via the motor male connector 126. In some embodiments, the motor female connector 124 has the same connection interface as the outlets of the distribution box 114 (e.g., both have three ports for a plug) and the motor male connector 126 has the same interface as the distribution box male connector 116 (e.g., both have a plug with three prongs to couple to three ports of an outlet). The motor female connector 124 and the motor male connector 126 may both be waterproof to prevent damage to the electrical wiring of the mower 600.

The left and right chore motors/controllers 122, 120 can each include a chore motor and a chore motor controller in the same enclosure. The respective motor controllers of left and right chore motors/controllers 122, 120 are electrically and communicably coupled to the distribution box 114 via the combined cable 118, the motor female connector 124, and the distribution box male connector 116 (i.e., via the cord 119). The left and right chore motors/controllers 122, 120 can be water tight and/or dust tight. This can prevent any electronic components within the built-in motor controllers from becoming damaged. Since the left and right chore motors/controllers 122, 120 may be sealed, all communication between the components (e.g., controllers) of the right chore motor/controller 120 and the left chore motor/controller 122 may be internal wiring/communication bus connections. In some embodiments, when the left and right chore motors/controllers 122, 120 are communicably coupled to other external controllers, motors, and/or controller modules (e.g., a controller of the mower, traction motor controller 106, right traction motor 110, etc.), a water tight and/or dust tight wiring interface can be utilized to wire the controllers of the left and right chore motors/controllers 122, 120 to the external components.

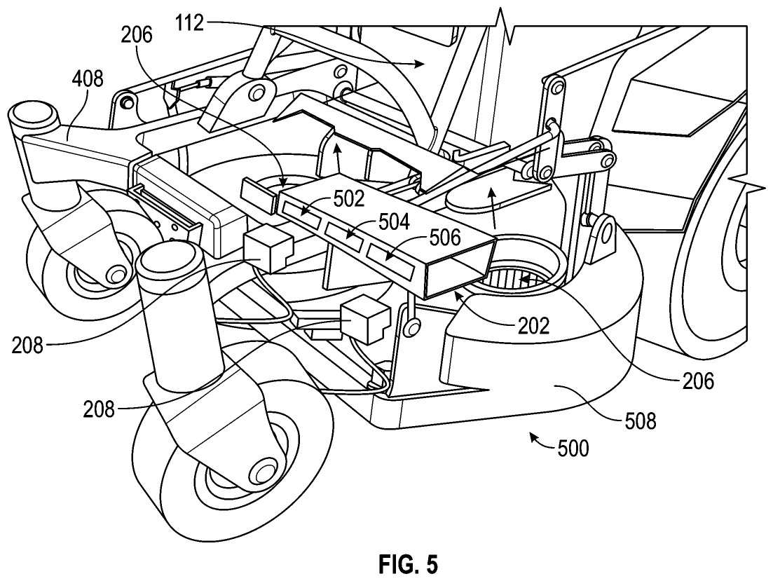

The left and right chore motors/controllers 122, 120 may each include a motor controller that is electrically and communicatively coupled to the motor and configured to control the motor of the electrically powered outdoor power equipment. The left and right chore motors/controllers 122, 120 may be positioned in the cutting deck 508 (FIG. 5) of the mower, where each of the chore motors/controllers 122, 120 is coupled to and configured to rotate cutting blades 128 positioned below the deck 508. The cutting deck 508, the chore motors/controllers 122, 120, and the cutting blades 128 are positioned near the front of the mower 600 (FIG. 6) (e.g., significantly opposite from the area the operator stands in while operating the mower). In some embodiments, more or less chore motors/controllers 122, 120 may be included in the mower. In another embodiment, the built- in chore motor controllers may be positioned separate from the chore motors of the left and right chore motors/controllers 122, 120 (e.g., FIG. 2). When a motor controller is in a separate location from the motor, the outlets of the distribution box 114 may be modified to include different outlets than in the scenario of diagram 100 in order to facilitate connections to the remote motor controller (e.g., chore motor controller 204 as shown in FIG. 2).

Referring now to FIG. 2, a diagram 200 showing another embodiment of the modular wiring for an electric vehicle (e.g., a stand-on electric mower) is illustrated. FIG. 2 is another exemplary embodiment of the diagram 100, where the motor controller is a remote motor controller and in a separate position on the electric vehicle from the motor instead of built-in with the motor. The diagram 200 is shown to include display 102, inputs 104, traction motor controller 106, left traction motor 108, right traction motor 110, battery 112, distribution box 202, distribution box male connectors 208, chore motor controllers 204, chore motors 206, a cord 209 having a combined cable 118 and male and female connectors, combined cable 210, and PTO ports 203. A main difference between the embodiments of the diagram 100 and the diagram 200 is the positioning of the chore motor controllers 204 separate from the chore motors 206, whereas in the diagram 100, the motor controllers were built-in with the motor and in the same location.

The chore motor controllers 204 may be the same or similar as the motor controllers used in the left and right chore motors/controllers 122, 120 shown in FIG. 1. The chore motor controllers 204 operate to control chore motors 206 and can be located near the chore motors 206 on the cutting deck 508 (FIG. 5) of a mower, mounted proximate the battery 112 that provides the chore motor controllers 204 with electrical energy, or positioned elsewhere on the electric vehicle. In some embodiments, the chore motor controllers 204 can be located on the cutting deck 508 of an electric mower (e.g., mower 600 (FIG. 6)). The chore motor controllers 204 can be configured to select direction of rotation of the chore motors 206, select and regulate speed of the chore motors 206, regulate or limit torque of the chore motors 206, and/or protect against overloads and other faults. In some embodiments, the chore motor controllers 204 may perform cutting load based control of the electric vehicle speeds, may identify the size of a deck (e.g., 36-inch, 48-inch, etc.) for a piece of outdoor power equipment, may optimize blade rotational speed based on the blade size used in the identified deck, and various other features of the chore motors 206. In other embodiments, this load based control, identification of deck size, identification of implements, and blade speed control may be done via a separate vehicle control unit (VCU) or via operator input (e.g., via inputs 104). Each of the chore motors 206, the left traction motor 108, and the right traction motor 110 may have separate motor controllers. In some embodiments, one or more motor controllers 204 may be housed within a single controller module. In other embodiments, the chore motor controllers 204 and/or traction motor controller 106 can be integrated into the housing of the battery 112.

The chore motor controllers 204 described herein include a communications port. The communications port can be configured to communicate with other motor controllers (e.g., via CAN bus communication lines 140, can include analog inputs, analog outputs, digital inputs, digital outputs, a motor position sensor connection, and/or other motor sensor inputs). Using a communications bus can reduce and/or minimize cabling. In some embodiments, the communications port includes two analog inputs, one analog output, digital input/output connections, CAN 2.0b connections, a motor position sensor input, and other motor sensor inputs. The chore motor controllers 204 may include an enclosure including one or multiple motor controllers for controlling electric motors of an electric vehicle or other equipment suitable to be powered by electric motors. In some embodiments, the chore motor controllers 204 are located near the chore motors 206 (or other element or component controlled by the chore motor controllers 204, reducing susceptibility to electromagnetic interference due to shorter signal lines) and only require motor phase lead connections and power connections. This distance and/or small number of required connections can decrease electromagnetic interference, thereby improving electromagnetic compatibility. In some embodiments, the chore motor controllers 204 are connected directly to the battery 112 for operating the chore motors 206.

In this embodiment, the chore motor controllers 204 are connected to the distribution box 202 via cords 209. Each of the chore motor controllers 204 are coupled to a chore motor 206 via the combined cable 210, the motor phase U line 134, the motor phase W line 136, and the motor phase V line 138. In some embodiments, the combined cable 210 (or harness) includes Hall position sensor wires, temperature sensor wires, a ground wire, and a low-voltage wire. The sensor data transmitted over these wires may be used by the chore motor controllers 204 to control and protect the connected chore motor 206. The combined cable 210 also may connect the traction motor controller 106 to the left and right traction motors 108 and 110. The positive 48V power line 130 and the negative 48V power line 132 may not be used to connect the chore motor controllers 204 to the distribution box 202. The cord 209 may include a distribution box male connector 208, a combined cable 118, and a female connector (e.g., the same as or similar to the female connector 124). The cord 209 (e.g., via the female connector) may connect to a male connector (e.g., similar to the motor male connector 126) coupled to the chore motor controllers 204. In some embodiments, the connection interface of the distribution box male connector 208 and the male connection interface of the chore motor controllers 204 are different. In some embodiments, the traction motor controller 106 can also connect to the distribution box 202 using the same connecting strategy as the connecting strategy between the chore motor controllers 204 and the distribution box 202. The distribution box 202 may be similar as the distribution box 114 of FIG. 1, but with different connection interfaces (e.g., different number of PTO ports 203 in the distribution box, different types of PTO ports 203, etc.). In some embodiments, the distribution box 202 is installed on a portion of the frame of the mower proximate the chore motors 206 and slightly above a cutting deck of the mower.

In some embodiments, the PTO ports 203 (used herein interchangeably with the term outlets) of the electric vehicle are in a single location, such as integrated with the distribution box 202. The PTO ports 203 may include power lines and a communication line. In some embodiments, the PTO ports 203 may include power ports to couple an implement that only uses power and does not receive communications from the controllers of the electric vehicle. As such, the PTO ports 203 may be selectively connected to implements to provide power to the implements. The electric vehicle may include several PTO ports 203 in the distribution box 202 that are the same or similar as the connection interfaces of the connectors 304, 318, or 320 of FIG. 3. The PTO ports 203 may also be other variations of outlets, such as USB outlets, three prong outlets, etc. For example, the PTO ports 203 may include a USB Type A or Type C port for charging a mobile device of an operator of the electric vehicle.

In other embodiments, the PTO ports 203 are in a separate location from the distribution box 202 (shown by the dashed line of PTO ports 203). For example, the PTO ports 203 may be directly integrated with the battery 112, in a separate distribution box 202 proximate the rear drive wheels of the electric vehicle, proximate an operator area of the electric vehicle, and/or integrated with a dashboard 602 (FIG. 6) of the electric vehicle. As such, an operator of an electric vehicle may have several options for connecting an implement or a secondary power supply into a PTO port 203 and may select a PTO port 203 to use based on which location of the PTO ports 203 is most convenient for the operator. For example, a PTO port 203 proximate a motor of the electric vehicle may be the most convenient to physically and electrically connect one or more chore motors 206.

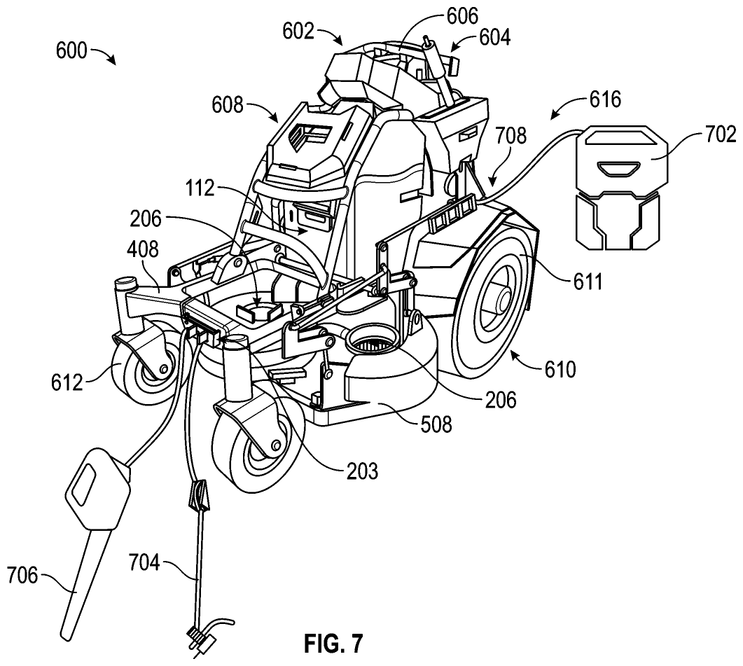

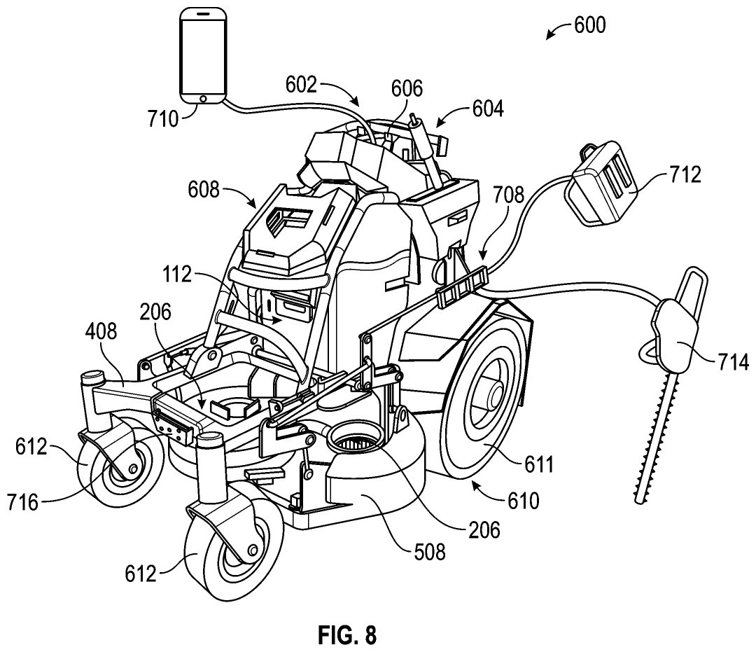

The PTO ports 203 can electrically and physically connect to implements to power the implements from the battery 112 of the electric vehicle. For example, a vacuum coupled to a PTO port 203 positioned proximate the rear drive wheels of the electric vehicle can be powered while simultaneously operating the electric vehicle, such as a mower, to remove debris from the area during operation. By having several PTO ports 203, an operator may use multiple implements (e.g., as shown in FIGS. 7 and 8) while operating the electric vehicle during a job. As such, the operator may reduce the amount of time needed to complete the job and the amount of battery power used, thus improving efficiency and cost to operate the electric vehicle.

In some embodiments, the PTO ports 203 are configured as charging ports for an electric vehicle (e.g., a vehicle that operates using a purely electric system or using a hybrid system). The PTO ports 203 can be used to couple to connection interfaces of a secondary power supply (e.g., a backup battery pack, portable generator, etc.). The multiple PTO ports 203 may receive ancillary battery packs to recharge the main power supply, such as battery 112, of the electric vehicle. Accordingly, when the battery 112 runs out of stored energy during operation of the electric vehicle (e.g., during a job), portable, backup battery packs can recharge the battery 112 so the operator can then drive the electric vehicle back to a transportation vehicle or charging station. In some embodiments, an Internet of Things (IoT) system is integrated into the electric vehicle. The IoT system may be configured to detect battery state-of-charge and whether the battery 112 of the electric vehicle is being recharged by a predetermined time. The IoT system can be configured to transmit a notification to a mobile device of an operator of the electric vehicle if it is determined that the battery 112 is not recharging by a predetermined time. For example, if the primary power supply of the electric vehicle is not charging by 8:00 PM, the IoT system may send an alert to a mobile phone of the operator, reminding the operator to connect a battery pack, portable generator, or other secondary power supply to one of the PTO ports 203 to recharge the battery 112.

The PTO ports 203 can be configured to receive power from a battery pack to selectively provide power to motors of the electric vehicle (e.g., chore motors 206, drive wheel motors of an ATV, etc.). For example, during a “transport mode” for the electric vehicle, the PTO ports 203 may only direct power received from coupled backup battery packs to drive wheel motors (e.g., left traction motor 108 and right traction motor 110). Furthermore, a programmable user interface of a dashboard (e.g., dashboard 602 (FIG. 6) or a separate VCU can be configured to selectively disable power to an auxiliary component of the electric vehicle (e.g., an electric mower) during a “transport mode.” For example, a programmable user interface or a separate VCU may be configured to selectively enable power to the one or more drive wheel motors, such as left traction motor 108 and right traction motor 110. The programmable user interface or separate VCU may disable power to the chore motors 206 during a “transport mode,” when an operator desires to drive the electric vehicle back to a trailer, rather than use the power of the battery 112 to operate the chore motors 206.

More than one battery pack can couple to the PTO ports 203 to recharge the battery 112 simultaneously. As such, the battery 112 may quickly recharge, charging at a much faster rate than if only one battery pack was able to connect to the electric vehicle to recharge the battery 112. More than one generator and/or charger can also couple to the PTO ports 203 to recharge the battery 112 of the electric vehicle at an accelerated rate of charging. The secondary power sources can also be used to couple to PTO ports 203 to recharge a power supply of a vehicle that operates, at least in part, on gasoline. In some embodiments, a programmable user interface of a dashboard (e.g., dashboard 602 (FIG. 6)) of the electric vehicle is configured to selectively power on or power off each of the several PTO ports 203. For example, the programmable user interface may include options to only enable power to PTO ports 203 proximate a deck or an operator area of the electric vehicle, or only enable power to PTO ports 203 that are connected to traction motors of the electric vehicle. The programmable user interface may also allow an operator to switch on and off a “transport mode” for the electric vehicle. Furthermore, the user interface of the electric vehicle can display whether or not a battery pack, implement, unknown item, etc. is coupled to each of the PTO ports 203.

Still referring to FIG. 2, the chore motors 206 may be liquid-cooled. In some embodiments, the left traction motor 108 and the right traction motor 110 may both be liquid-cooled. Each of the chore motors 206 and traction motors 108 and 110 can include a rotor assembly, a stator assembly, and a liquid-cooled or air-cooled housing. The chore motors 206 are electrically coupled to and powered by the battery 112. The operation of the chore motors 206 are controlled by the remote chore motor controllers 204. Accordingly, each of the chore motors 206 are electrically, communicably, and operatively coupled to a chore motor controller 204.

Referring now to FIG. 2B, a diagram 200′ showing another embodiment of the modular wiring for a piece of outdoor equipment (e.g., a stand-on electric mower) is illustrated. FIG. 2B is another exemplary embodiment of the diagram 100, where the motor controller is a remote motor controller and in a separate position on the mower from the motor instead of built-in with the motor. The diagram 200′ is shown to include display 102′, inputs 104′, traction motor controller 106′, left traction motor 108′, right traction motor 110′, battery 112′, distribution box 202′, distribution box male connectors 208′, chore motor controller 204′, chore motors 206′, and a cord 209′ having a combined cable 118′ and male and female connectors. The main difference between the embodiments of the diagram 100 and the diagram 200′ is the positioning of the chore motor controller 204′ separate from the motors 206′, whereas in the diagram 100, the motor controller was built-in with the motor and in the same location. The chore motor controller 204′ may be the same or similar as the motor controllers used in the motors 120, 122 shown in FIG. 1. The chore motor controller 204′ operates to control chore motors 206′ and can be located near the chore motors 206′ on the cutting deck 508 (FIG. 5) of the mower, mounted proximate the battery 112′ that provides the chore motors 206′ with electrical energy, or positioned elsewhere on the equipment. In some embodiments, the chore motor controller 204′ can be located on the cutting deck 508 of the mower 600 (FIG. 6). The chore motor controller 204′ can perform load based control of mower speeds, can identify the size of the deck (e.g., 36-inch, 48-inch, etc.), and can optimize cutting speed based on the width of the identified deck, and various other features of the chore motors 206′. In some embodiments, each of the chore motors 206′, the left traction motor 108′, and the right traction motor 110′ have separate motor controllers. In some embodiments, one or more motor controllers 204′ may be housed within a single controller module. In other embodiments, the chore motor controller 204′ can be integrated into the housing of the battery 112′.

The chore motor controller 204′ described herein includes a communications port. The communications port can be configured to communicate with other motor controllers (e.g., via CAN bus communication lines 140′, can include analog inputs, analog outputs, digital inputs, digital outputs, a motor position connection, and/or motor sensor inputs). Using a communications bus can reduce and/or minimize cabling. In some embodiments, the communications port includes two analog inputs, one analog output, digital input/output connections, CAN 2.0b connections, a motor position input, and motor sensor inputs. The chore motor controller 204′ may include an enclosure including one or multiple motor controllers for controlling electric motors of a piece of outdoor power equipment or other equipment suitable to be powered by electric motors. In some embodiments, the chore motor controller 204′ is located near the chore motors 206′ (or other element or component controlled by the chore motor controller 204′, reducing susceptibility due to shorter signal lines) and only requires motor connections, power connections, and/or CAN connections. This distance and/or small number of required connections can decrease electromagnetic interference, thereby improving electromagnetic compatibility. In some embodiments, the chore motor controller 204′ is connected directly to the battery 112′ for operating the chore motors 206′.

In this embodiment, the chore motor controller 204′ is connected to the distribution box 202′ via the motor phase U line 134′, the motor phase W line 136′, and the motor phase V line 138′. The positive 48V power line 130′ and the negative 48V power line 132′ may not be used to connect the chore motor controller 204′ to the distribution box 202′. A cord 209′ may connect the chore motors 206′ to the distribution box 202′. The cord 209′ may include a distribution box male connector 208′, a combined cable 118′, and a motor female connector 124′. The cord 209′ (via the motor female connector 124′) may connect to a male connector (e.g., the motor male connector 126′) coupled to the chore motors 206′. In some embodiments, the connection interface of the distribution box male connector 208′ and the connection interface of the motor male connector 126′ are different. In diagram 200′, the wiring of the traction motor controller 106′ is shown as the same as in the wiring of the traction motor controller 106 of FIG. 1. However, in other embodiments, the traction motor controller 106′ can also connect to the distribution box 202′ using the same connecting strategy as the connecting strategy between the chore motor controller 204′ and the distribution box 202′. The distribution box 202′ may be similar as the distribution box 114 of FIG. 1, but with different connection interfaces (e.g., different number of ports in the outlets, different number of outlets, different types of ports, such as motor phase ports instead of power ports). In some embodiments, the distribution box 202′ is installed on a portion of the frame of the mower near the chore motors 206′ and slightly above a cutting deck of the mower.

The chore motors 206′ may be liquid-cooled. In some embodiments, the left traction motor 108′ and the right traction motor 110′ may both be liquid-cooled. Each of the chore motors 206′ can include a rotor assembly, a stator assembly, and a housing. The chore motors 206′ are electrically coupled to and powered by the battery 112′. The operation of the chore motors 206′ are controlled by the remote chore motor controller 204′. Accordingly, the chore motors 206′ are electrically, communicably, and operatively coupled to the chore motor controller 204′.

Referring now to FIG. 3, a schematic diagram 300 of examples of connection interfaces that are included in the distribution box 114 or the distribution box 202 is illustrated, according to exemplary embodiments. The connectors described herein may be similar to those described in U.S. Pat. No. 7,806,737, which is incorporated herein by reference in its entirety. The diagram 300 is shown to include a connector 304 with a connection interface 305, a connector 318 with a connection interface 319, and a connector 320 with a connection interface 321. The connector 304 is used as an outlet (e.g., PTO port 203) in the distribution box 114 for connecting to one or more motors and/or one or more implements that draw a certain amount of current (e.g., 100 A). The connector 304 includes two 50 A positive, cylindrical, power ports 306 on one side of a data connection port 302. On the other side of the data connection port 302, the connector 304 includes two 50 A negative, cylindrical, power ports 308. In some embodiments, the distribution box male connector 116 includes five pins on the plug of the male connector to connect to each port of the connector 304. The connector 304 is asymmetrical, thereby reducing the ability to reverse polarity while connecting the connector 304 and a PTO outlet or port.

FIG. 3 is also shown to include a connector 318 with a connection interface 319. The connector 318 can be for chore motors 206 that are connected with a remote motor controller, such as in the diagram 200, where the motor controller (e.g., a chore motor controller 204) is separate from the motor (e.g., chore motors 206). As such, connector 318 can be utilized to couple motors and their respective motor controllers. The connector 318 includes a U motor phase port 310, a V motor phase port 312, a data connection port 314, and a W motor phase port 316. The U motor phase port 310 may be connected with motor phase U lines 134, V motor phase port 312 may be connected with motor phase V lines 138, and the W motor phase port 316 may be connected with the motor phase W lines 136. The ports of the connector 318 may be structured mechanically for a keying strategy (e.g., a poka-yoke to prevent equipment operating errors) such that only one connector is able to couple to an outlet of the motor controller (e.g., chore motor controller 204) with a connection interface the same as the connector 318. In some embodiments, a connector 320 with a connection interface 321 is used for outlets of the distribution box 114 for a standard 48V connection. In other embodiments, the outlets of the distribution box 114 are used with a different voltage than a 48V connection (e.g., more or less than 48V connection). The connector 320 may be used when the motor and the motor controller are integrated in a single housing on the mower. The connector 320 includes a single, cylindrical, negative power port 322, a data connection port 324, and a single, cylindrical, positive power port 326, where the two power ports 322 and 326 are each on opposite sides of the data connection port 324. The connector 320 may be an outlet that can supply 50 A of current to motors and/or implements. In some embodiments, the connector 304 supplies double the amount of current supplied by the connector 320. In other embodiments, the connector 304 and the connector 320 supply more or less than 100 A and 50 A of current, respectively.

In some embodiments, a distribution box male connector 116 that has the mating interface (e.g., two pins for power and a pin for data connection positioned in between the two power pins) to plug into an outlet (e.g., PTO port 203) with an interface of the connector 320 may also be plugged directly into an outlet with an interface of the connector 304. In this instance, the outermost power ports are unused and may be covered. In some embodiments, the distribution box 114 may have more outlets than outlets that have a motor or implement selectively connected, and the open outlets may then be covered up with a male connector cover such that no outlets are open and exposed. The CAN communication lines 140 may connect to the data connection ports of each example connection port of FIG. 3. When an implement or motor is connected to an outlet of the distribution box, the display 102 may show what type and size of implement (e.g., one large blower versus two smaller brushes) or motor is connected, which may be self-identified by the communication line between the data connection ports.

In some embodiments, the connectors 305, 318, and 320 shown in FIG. 3 eliminate the data connection ports 302, 314, and 324. For example, the data connection ports 302, 314, and 324 may be provided in a separate connector. In some embodiments, the data connection ports 302, 314, and 324 are coupled to separate data cables that are separate from the power cables, but the data connection ports 302, 314, and 324 themselves are structurally arranged within the connectors 305, 318, and 320. In some embodiments, the separate data cables and/or separate data connectors couple directly to the distribution box 202, 202′ discussed above so that data and power are provided in parallel with simplified connectivity.

In some embodiments, the cables and data connection ports 302, 314, and 324 include active or passive shielding to inhibit the influence of electrical noise produced by power cables and ports. For example, an embedded shielding 328 is shown in FIG. 3.

In some embodiments, the connectors 305, 318, and 320 define an industry standard connection profile, so that third party accessories, chore motors, or other components can be connected readily to the distribution box 202. In some embodiments, other asymmetric industry standard or proprietary connection profiles can be implemented.

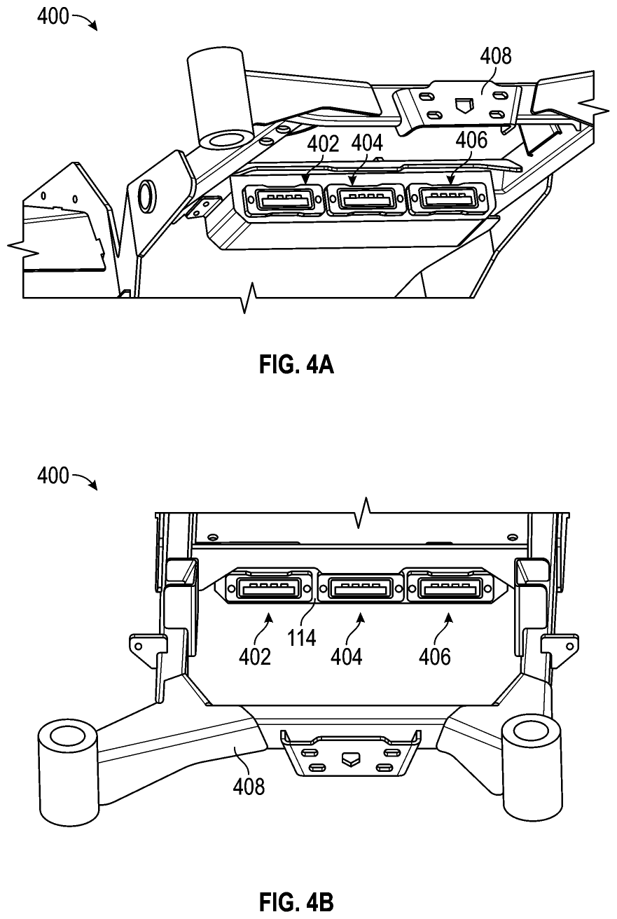

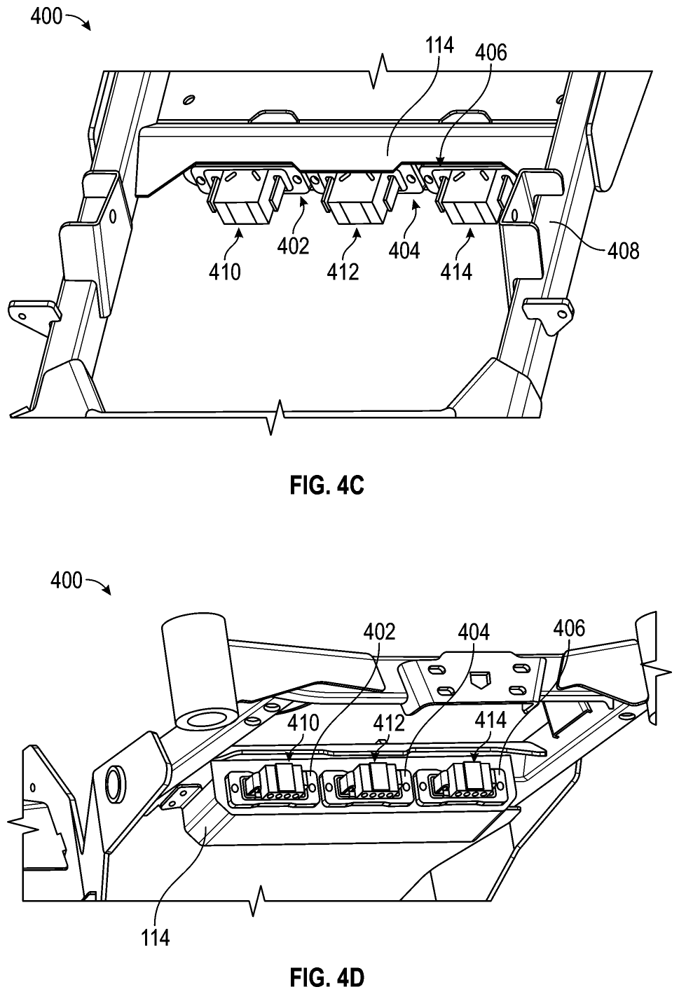

Referring now to FIGS. 4A and 4B, a perspective view 400 of the distribution box 114 assembled on the frame of a mower from different perspectives is illustrated, according to exemplary embodiments. FIGS. 4A-4B are shown to include the same components, with FIG. 4B illustrating the view 400 from an angle above a portion of the frame 408 of the mower. FIGS. 4A-4B include the distribution box 114 coupled to the portion of the frame 408. The distribution box 114 can include three PTO ports, PTO port 402, PTO port 404, and PTO port 406. The PTO ports may have one of the connection interfaces 305, 319, or 321 as described in FIG. 3. In some embodiments, the PTO ports 402, 404, and 406 all have the same openings for the distribution box male connector 116 to couple to the distribution box 114. In other embodiments, the PTO port 402, PTO port 404, and PTO port 406 may each have a different connection interface. For example, the PTO port 402 may have a connection interface the same as the connector 304, the PTO port 404 may have a connection interface the same as the connector 318, and the PTO port 406 may have a connection interface the same as the connector 318 as well. The open space of the frame in front of the distribution box 114 may be directly over the cutting deck 508 (FIG. 5) of the mower. In some embodiments, the distribution box 114 includes the PTO ports or outlets 402, 404, 406. In some embodiments, the lawn mower or other power equipment can include multiple distribution boxes including PTO ports located in different locations around the power equipment. For example, a combined distribution box may be arranged adjacent the deck, and a second distribution box may be positioned adjacent a user interface. In some embodiments, the chore motor connectors and the PTO connectors are identical and interchangeable. In some embodiments, the combined distribution box includes different connection types (e.g., USB, connector 304, 12 v socket, etc., 120 VAC outlet).

FIGS. 4C-4D depict a perspective view 400 of the distribution box 114 assembled on the frame of a mower with male connectors coupled to the PTO ports as shown in FIGS. 4A-4B, according to exemplary embodiments. FIGS. 4C-4D are shown to include the same components, with FIG. 4D illustrating the view 400 of the distribution box 114 from an angle below a portion of the frame 408 of the mower. In some embodiments, male connector 410, male connector 412, and male connector 414 are each covers for the PTO ports 402, 404, and 406 that plug into the openings of the PTO port (e.g., the power port 322, the power port 326, and the data connection port 324 of the connector 320). In other embodiments, the male connector 410, the male connector 412, and the male connector 414 are the same as the distribution box male connector 116 and are attached to a combined cable (not shown) of power and communication lines (e.g., the combined cable 118). The male connectors 410, 412, and 414 may have the same connection interface (e.g., number of pins and same plug size) as the motor male connector 126 that is coupled to the left and right chore motors 122 and 120.

FIG. 5 depicts a front perspective view 500 of a portion of an electric stand-on mower and the position of the distribution box 202, according to an exemplary embodiment. The view 500 is shown to include the portion of the frame 408, the battery 112, the chore motors 206 on separate sides of a cutting deck 508, the distribution box 202, and PTO ports 502, 504, and 506. The PTO ports 502, 504, and 506 may be similar to the PTO ports of FIGS. 4A-4D with different connection interfaces for the distribution box 202. The distribution box 202 may couple to the underside of the portion of the frame 408 beneath and near the battery 112 to allow short connection lines between the distribution box 202 and the battery 112. The distribution box 202 may also be centered and near the cutting deck 508 in order to easily run connection lines (e.g., DC power lines, communication lines, etc.) down to the chore motors 206 and any other implements. The distribution box male connectors 208 may couple to one of the PTO ports of the distribution box 202 and the cable (e.g., the combined cable 118) from the male connectors 208 may then connect to the chore motors 206 via a female connector (e.g., motor female connector 124) plugging into a male connector coupled to the chore motors 206 (e.g., the motor male connector 126). In some embodiments, the distribution box 202 has more or less PTO ports than shown in FIG. 5 and has covers for any PTO ports without a connection to a motor or an implement.

FIG. 6 illustrates a piece of outdoor power equipment, in the form of a stand-on electric mower 600, which includes one or more traction motors (e.g., left traction motor 108 and right traction motor 110) and one or more chore motors 206 electrically coupled to and powered by the battery 112. The wiring system used in diagram 100 may be used in purely electric systems (e.g., only the battery 112 is used to power the stand-on electric mower 600) or may be used in hybrid systems. For example, the distribution box, connectors, and motors described herein may be used in systems including an internal combustion engine and generator or systems including an internal combustion engine, a generator, and a battery. The chore motors 206 are coupled to a rotary tool, such as the blade (e.g., cutting blade 128) in the cutting deck 508 of the mower 600, an auger, a saw, tines, a drill, a pump, or other rotary tools. The mower 600 includes rear drive wheels 610, with an axle 611 of the rear drive wheels 610, and front caster wheels 612. The rear drive wheels 610 are each driven by the left traction motor 108 and the right traction motor 110. In other embodiments, the mower 600 can include more or less drive wheels and/or traction motors. An operator area 616 is positioned proximate the rear of the mower 600, where the operator faces toward the front of the mower 600 while in operation. The operator area 616 includes a platform on which the operator stands while operating the mower 600. The platform may include sensors to detect when the operator is positioned on the platform (e.g., to operate chore motors 206, etc.).

The drive levers 604 are coupled to the traction motor controller 106 which control the left traction motor 108, right traction motor 110 (shown in FIG. 1), which are coupled to (e.g., engage with) and control the rotation of the rear drive wheels 610. The rear drive wheels 610 rotate differently in response to various operator inputs 104 at the drive levers 604. Accordingly, when the operator moves the drive levers 604 in a forward direction, the rear drive wheels 610 rotate in a forward direction to propel the mower 600 forward. When the operator moves the drive levers 604 in a backward direction, the rear drive wheels 610 rotate in the backward direction to drive the mower 600 backward. In addition, when the right or left drive levers 604 are moved forward or backward separately (e.g., right drive lever is moved separately from the left drive lever), the traction motors (e.g., the left traction motor 108 and the right traction motor 110) and rear drive wheels 610 respond accordingly. For example, when the right drive lever is moved forward and the left drive lever remains stationary, the right rear drive wheel 610 is rotated faster than the left drive wheel 610 and the mower 600 is caused to move to the left, and vice versa.

The mower 600 includes a dashboard 602 operable by the operator to control certain operating or performance conditions of the mower 600. The dashboard 602 includes a programmable user interface, which displays current operating conditions, maintenance notifications and/or warnings to the operator (e.g., two implements connected to the distribution box 114 are drawing an amount of current that is approaching a safety threshold level). The dashboard 602 and user interface are positioned in view of the operator such that when the operator is standing on the platform, the operator can clearly see the dashboard 602 and user interface in his or her line of sight. Accordingly, the dashboard 602 and user interface are positioned near the center of the mower 600 proximate the drive levers 604 and handle 606. The user interface may include a touchscreen and/or selector interfaces (e.g., push-buttons, toggles, etc.) which may receive input (e.g., inputs 104) from the operator. Through interaction with the user interface, the operator inputs commands into a control system of the mower, which in turn, controls the mower 600 based on the operator input. In some embodiments, the programmable user interface of the dashboard 602 receives inputs to activate and/or deactivate implements connected to the distribution box 114 of the mower 600 in combination with actuation of a PTO switch (e.g., inputs 104). A separate PTO switch (e.g., inputs 104) may also engage or disengage the cutting blades 128.

The dashboard 602 can include indicators (e.g., one or more LEDs or numeric display) placed proximate the user interface which indicate, via color (e.g., red, yellow, green) or numbers, a power draw for each of the batteries (e.g., the battery 112) of the mower 600. In some embodiments, the indicator shows the efficiency with which the operator is operating the mower 600. In some embodiments, if the systems described herein are used on an outdoor power equipment that is a hybrid device, the dashboard 602 can indicate an amount of power being supplied by the battery 112 versus an internal combustion engine to the operator of the mower 600. Providing these power draw indications can specify to an operator which parts of the equipment are using power and in what amount. The dashboard 602 may also include indicators of whether one or more implements are connected to the distribution box 114 of the mower 600, and if so, how much power each implement is drawing in order to operate. In some embodiments, the dashboard 602 includes indicators of each of the connections to the PTO ports 203 of the mower 600. For example, the dashboard 602 may show whether any battery packs, generators, or chargers are coupled to the PTO ports 203 to recharge the battery of the mower 600. Furthermore, the dashboard 602 may display notifications from an IoT system to alert an operator of the mower 600 of any detected problems with the PTO ports 203 or charging issues for the power supply of the mower 600 (e.g., the battery 112 of mower 600 is or is not charging while a battery pack 702 (FIG. 7) is connected to the mower 600).

The dashboard 602 can include one or more LEDs, a display screen (e.g., display 102), a steering wheel, a throttle control, one or more drive sticks, buttons (e.g., one or more buttons) to enable a chore function (e.g., PTO switch for the PTO ports of the distribution box 114, turn on lawn mower blades, turn off lawn mower blades, select blade speed, turn on lights connected to the distribution box 114, turn off lights connected to the distribution box 114, etc.), and/or any other input and/or output device. In some embodiments, the dashboard 602 may include a lockout input device, such as a switch, to send an input 104 to permit power to the chore motors 206.

Referring now to FIG. 7, the connections of multiple devices to an electric vehicle (e.g., mower 600) is shown, according to an exemplary embodiment. FIG. 7 shows the connection of a battery pack 702 and implements 704 and 706 to multiple outlets (e.g., PTO ports 203) of the mower 600. In some embodiments, implement 704 is a trimmer and implement 706 is a blower. In other embodiments, other kinds of implements, such as a chainsaw, vacuum, light, etc., may be physically and electrically connected to the mower 600. The implements 704 and 706 may couple to the electric vehicle at an accessory mount (e.g., accessory mount 716 (FIG. 8)) near the front drive wheels 612 of the electric vehicle. As such, the implements 704 and 706 may both operate using the power supply (e.g., battery 112) of the mower 600. In some embodiments, the dashboard 602 may include controls for the operation of implements 704 and 706. For example, a user interface of dashboard 602 may display the detected implements coupled to the mower 600 and provide options to an operator of the mower 600 to turn on or off the implements 704 and 706. In some embodiments, the dashboard 602 may also display how much energy that the implements 704 and 706 connected to PTO ports 203 are using from the mower's 600 power supply (e.g., battery 112). In other embodiments, instead of the implements 704 and 706 being coupled to multiple PTO ports 203 proximate or in an accessory mount (e.g., accessory mount 716, shown in FIG. 8) of the mower 600, the implements 704 and 706 are coupled to PTO ports 203 integrated with the battery 112. Additionally, the implements 704 and 706 may instead be connected to the mower 600 proximate the side of the mower 600, such as above the rear drive wheels 610. For example, the implement 706 may instead be coupled to PTO ports 203 of the mower 600 using distribution box 708, which includes several PTO ports 203. The distribution box 708 may be the same or similar as distribution box 202 (FIG. 2), but with different configurations of PTO ports 203.

In some embodiments, the battery pack 702 is also coupled to the mower 600 to provide backup battery power to battery 112 of the mower 600. For example, the battery pack 702 is a portable, secondary power supply that couples to one of several PTO ports 203 in the distribution box 708 to recharge the primary power supply (e.g., battery 112) of the mower 600. In some embodiments, the battery pack 702 is coupled to the PTO ports 203 of the mower 600 as a secondary power supply to power motors (e.g., chore motors 206) of the mower 600. The battery pack 702 may have a connection interface that couples to the PTO ports of distribution box 708. For example, the battery pack 702 may be connected to the distribution box 708 via a cable that is similar to cable 119 with distribution box male connectors 116. In other embodiments, the battery pack 702 may instead be electrically and physically coupled to the mower 600 using the PTO ports 203 proximate the front of the electric vehicle, such as PTO ports 203 of an accessory mount where implements 704 and 706 are shown to be connected to the mower 600. In some embodiments, more than one battery pack 702 may be used to recharge the primary power supply of the mower 600 simultaneously. As such, the primary power supply (e.g., battery 112) of mower 600 may experience a “quick recharge.” By decreasing the amount of time waiting to charge the main power supply of the mower 600, an operator may increase the efficiency of use of mower 600 and complete jobs at a faster rate.

Referring now to FIG. 8, additional connections of multiple devices to the electric vehicle (e.g., mower 600) is shown, according to some embodiments. FIG. 8 shows the connection of a mobile device 710 to a PTO port 203 proximate the operator area 616, as well as connections of implement 712 and another implement 714 coupled to the distribution box 708 (e.g., via PTO ports 203). In some embodiments, implement 712 is a pressure washer and implement 714 is a chain saw. The battery supply (e.g., battery 112) of the electric vehicle may be used to operate implement 712 and implement 714. In some embodiments, the implements 712 and 714 may only run using the battery 112 of the mower 600 if a VCU (vehicle control unit) or programmable user interface detects a predetermined level of battery charge in order to have sufficient power to continue operation of the mower 600 for an amount of time. In other embodiments, the implements 712 and 714 instead couple to PTO ports 203 positioned in an accessory mount 716. The accessory mount 716 can be positioned proximate the front of the mower 100 between the front caster wheels 612. A variety of implements (i.e., accessories) can be coupled to the accessory mount 716, such as blowers, vacuums, trimmers, lights, other battery-powered tools, etc. In other embodiments, the PTO ports 203 of the mower 600 are positioned in a single location, such as in distribution box 708 above the rear drive wheels 610. In some embodiments, a user of the mower 600 may recharge a mobile device 710 using the battery 112 of the mower 600. For example, a mobile device 710 (e.g., a smartphone, a mobile phone, a tablet device, etc.) of the operator may be connected to a PTO port 203 proximate or integrated with a user interface of the dashboard 602 to recharge the mobile device 710. In some embodiments, the PTO port 203 is a USB-Type A or Type C charging port that receives a charging cable for the mobile device 710. A PTO port 203 of the distribution box 708 or integrated with the accessory mount 716 may also be structured to receive and charge the mobile device 710, for example.

Within this application, chore motors, implements, mobile devices, external battery packs/supplies, or any other external component that plugs into or engages the PTO outlets or ports can be considered peripheral devices. Peripheral devices may provide or receive power form the PTO ports or outlets. Peripheral devices may include a peripheral controller (e.g., the motor controller 204) that is positioned onboard the peripheral device or external to the peripheral device. For example, an external peripheral controller may be coupled to the frame of the mower but control operation of the peripheral device. External peripheral controllers may be coupled to the PTO outlets or ports or distribution blocks as discussed above. In some embodiments, no peripheral controller exists and the PTO outlet/port or distribution box is able to determine if power is provided by the peripheral device or should receive power. Advantageously, the PTO outlets/ports and distribution boxes described herein provide and receive power seamlessly from a larger number of peripheral devices without difficulty.

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicably coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively, or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively, or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the embodiments might include a general purpose computing in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

The construction and arrangements of the present disclosure, as shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using one or more separate intervening members, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, or state machine. A processor also may be implemented as a combination of computing devices, such as a combination of a DSP and a microprocessor, a plurality of microprocessors, one or more microprocessors in conjunction with a DSP core, or any other such configuration. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is coupled to the processor to form a processing circuit and includes computer code for executing (e.g., by the processor) the one or more processes described herein.

Embodiments within the scope of the present disclosure include program products comprising machine-readable media for carrying or having machine-executable instructions or data structures stored thereon . Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the [apparatus, system, assembly, etc.] as shown in the various exemplary embodiments is illustrative only. Additionally, any element disclosed in one embodiment may be incorporated or utilized with any other embodiment disclosed herein. For example, the . . . of the exemplary embodiment described in at least paragraph(s) [ ] may be incorporated in the . . . of the exemplary embodiment described in at least paragraph(s) [ ]. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A lawn mower, comprising:
a frame;
a deck coupled to the frame; and
an electric power take off outlet coupled to the frame and structured to electrically couple with a battery, the electric power take off outlet including
a power port structured to electrically couple to a peripheral device, and
a data port structured to communicate with the peripheral device.

2. The lawn mower of claim 1, wherein the power port and the data port are collocated on a common connector.

3. The lawn mower of claim 2, wherein the common connector is asymmetrical in shape.

4. The lawn mower of claim 2, wherein the power port includes a positive power port and a negative power port, and the data port is positioned between the positive power port and the negative power port.

5. The lawn mower of claim 1, further comprising the peripheral device including a chore motor and a chore controller,
wherein the chore controller is structured to communicate with the data port and control when power is supplied from the power port to the chore motor.

6. The lawn mower of claim 1, wherein the electric power take off outlet is positioned adjacent the deck.

7. The lawn mower of claim 1, further comprising a mower electrical system including:
a traction motor controller,
an electric traction motor structured to receive power from a battery via the traction motor controller to propel the lawn mower, and
wherein the electric power take off outlet is structured to receive power from the battery.

8. The lawn mower of claim 1, wherein electrical power provided from the battery to the electric power take off outlet is interrupted when a state of charge of the battery is equal to or less than a threshold state of charge.

9. The lawn mower of claim 1, further comprising a distribution box including a plurality of electric power take off outlets.

10. The lawn mower of claim 1, wherein the data port is physically separated from the power port.

11. The lawn mower of claim 1, wherein the data port is shielded from the power port.

12. The lawn mower of claim 1, further comprising a user interface,
wherein the electric power take off outlet is positioned adjacent the user interface.

13. The lawn mower of claim 1, wherein the peripheral device includes an external power source structured to charge a lawn mower battery.

14. The lawn mower of claim 1, further comprising an internet of things (IoT) system structured to:
determine a state of charge of a battery coupled to the electric power take off outlet,
predict if the state of charge of the battery will equal or exceed a state of charge threshold within a predetermined time, and
transmit a notification to a mobile device when the state of charge of the battery is not predicted to equal or exceed the state of charge threshold within the predetermined time.

15. The lawn mower of claim 1, wherein the lawn mower includes a plurality of electric power take off outlets and further comprising a user interface structured to display each connection to the plurality of electric power take off outlets.

16. An electric vehicle comprising:
a frame;
a deck coupled to the frame; and
an electrical system including
a traction motor controller structured to receive power from a vehicle battery and provide power to an electric traction motor, and
a distribution box structured to electrically coupled with the battery and including a plurality of electric power take off outlets each including:
a power port structured to electrically couple a peripheral device, and
a data port structured to communicate with the peripheral device, and
a chore motor controller communicably coupled with the power port and the data port of a first electric power take off outlet.

17. The electric vehicle of claim 16, wherein the distribution box is positioned adjacent the deck.

18. The electric vehicle of claim 16, wherein a second electric power take off outlet is structured to provide power to a peripheral device.

19. The electric vehicle of claim 16, wherein a second electric power take off outlet is structured to receive power from an external power source to charge the battery.

20. An electric vehicle comprising:
a frame;
a deck coupled to the frame;
an electric chore motor coupled to the deck;
a chore motor controller communicably coupled to the chore motor;
a distribution box positioned adjacent the deck and electrically coupled with the electric chore motor and the chore motor controller to provide power and communication therebetween; and
an electric power take off outlet including
a power port structured to electrically couple a peripheral device, and
a data port structured to communicate with the peripheral device.
